(19) United States
(12) Patent Application Publication
(10) Pub. No.: US 2020/0303845 A1
(43) Pub. Date: Sep. 24, 2020

(54) CONNECTION MEMBER

(71) Applicant: KYOCERA Document Solutions Inc., Osaka (JP)

(72) Inventor: Minoru SHINBA, Osaka-shi (JP)

(73) Assignee: KYOCERA Document Solutions Inc., Osaka (JP)

(21) Appl. No.: 16/800,573

(22) Filed: Feb. 25, 2020

(30) Foreign Application Priority Data
Mar. 22, 2019 (JP) 2019-054586

(51) Int. Cl. H01R 4/70

(52) U.S. Cl. CPC H01R 4/70

(57) ABSTRACT

A connection member having a plate shape or a sheet shape includes a signal layer, a first insulating layer, and a second insulating layer. The signal layer is sandwiched between the first and second insulating layers. The signal layer is provided with a terminal and a signal line connected to the terminal. The terminal is positioned adjacent to an end of the connection member in a lengthwise direction of the connection member and exposed from the second insulating layer. The signal line extends away from the end. The connection member further includes a through-part going through the connection member in a thickness direction of the connection member. The thickness direction intersects the lengthwise direction.

### INCORPORATION BY REFERENCE

The present application claims priority under 35 U.S.C. § 119 to Japanese Patent Application No. 2019-054586, filed on Mar. 22, 2019. The contents of this application are incorporated herein by reference in their entirety.

### BACKGROUND

The present disclosure relates to a connection member.

A connection member has a plate shape or a sheet shape. The connection member includes a flexible flat cable (FFC). Alternatively, the connection member includes a flexible printed circuit (FPC).

Robots have been actively introduced into processes of manufacturing electronic devices. The robots are capable of performing assembly work of inserting, into a connector, the connection member that has the plate shape or the sheet shape.

### SUMMARY

A connection member having a plate shape or a sheet shape, according to an aspect of the present disclosure includes at least three layers of a signal layer, a first insulating layer, and a second insulating layer. The signal layer is sandwiched between the first and second insulating layers. The signal layer is provided with a terminal and a signal line connected to the terminal. The terminal is positioned adjacent to an end of the connection member in a lengthwise direction of the connection member and exposed from the second insulating layer. The signal line extends away from the end of the connection member. The connection member further includes a through-part going through the connection member in a thickness direction of the connection member. Here, the thickness direction intersects the lengthwise direction.

### BRIEF DESCRIPTION OF THE DRAWINGS

FIG. 1 is a plan view of an FFC that is a connection member according to an embodiment of the present disclosure.

FIG. 2 is a back view of the FFC.

FIG. 3 is a cross-sectional view taken along a line III-III in FIG. 1.

FIG. 4 is a cross-sectional view taken along a line IV-IV in FIG. 1.

FIG. 5 is a cross-sectional view of the FFC and illustrates a handling method thereof.

FIG. 6 is a plan view of an FFC as a variation.

FIG. 7 is a cross-sectional view taken along a line VII-VII in FIG. 6.

FIG. 8 is a plan view of an FFC as another variation.

FIG. 9 is a plan view of an FFC as still another variation.

FIG. 10 is a plan view of an FFC that is a connection member according to another embodiment of the present disclosure.

### DETAILED DESCRIPTION

Embodiments of the present disclosure will hereinafter be described with the accompanying drawings. In the present specification, an X axis, a Y axis, and a Z axis perpendicular to one another are defined for convenience. The X axis and the Y axis are parallel to a horizontal direction, and the Z axis is parallel to a vertical direction. In the drawings, the same or equivalent elements are allocated the same reference signs, and description thereof will not be repeated.

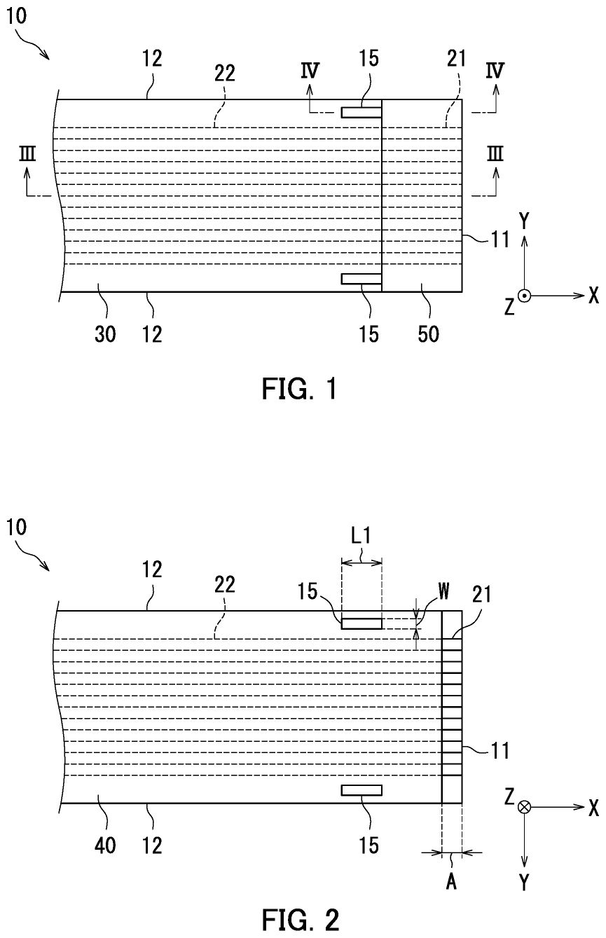

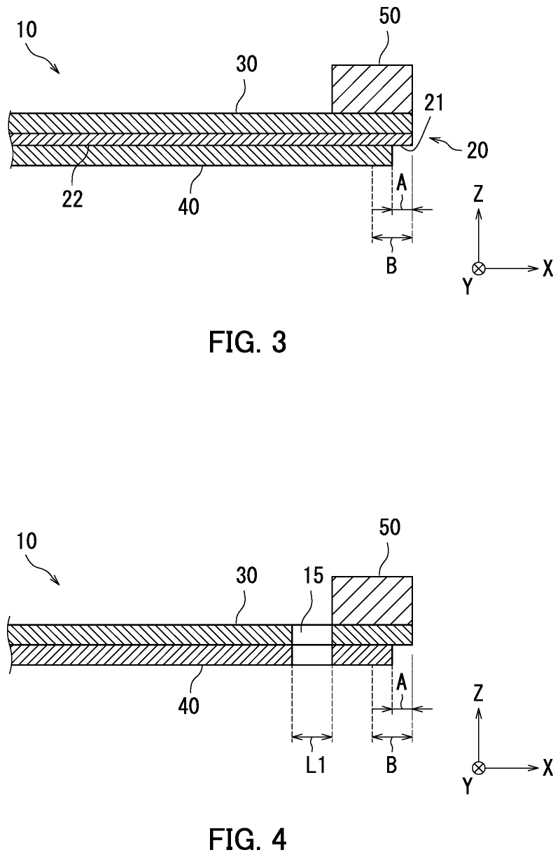

An FFC 10 that is a connection member according to an embodiment will first be described with reference to FIGS. 1 to 4. FIG. 1 is a plan view of the FFC 10. FIG. 2 is a back view of the FFC 10. FIG. 3 is a cross-sectional view taken along a line III-III in FIG. 1. FIG. 4 is a cross-sectional view taken along a line IV-IV in FIG. 1.

As illustrated in FIGS. 1 to 4, the FFC 10 has a plate shape or a sheet shape. A lengthwise direction of the FFC 10 matches an X-axis direction. A widthwise direction of the FFC 10 matches a Y-axis direction. Here, the widthwise direction intersects the lengthwise direction of the FFC 10. A thickness direction of the FFC 10 matches a Z-axis direction. Here, the thickness direction intersects the lengthwise direction of the FFC 10.

As illustrated in FIG. 3, the FFC 10 includes a signal layer 20, a first insulating layer 30, and a second insulating layer 40. The signal layer 20 is sandwiched between the first and second insulating layers 30 and 40.

As illustrated in FIGS. 1, 2, and 3, terminals 21 and signal lines 22 are formed in the signal layer 20. Here, the signal lines 22 are connected to the respective corresponding terminals 21.

As illustrated in FIGS. 2 and 3, the terminals 21 are positioned adjacent to an end 11 of the FFC 10 in an X-axis positive direction and exposed from the second insulating layer 40. The terminals 21 have their respective terminal lengths A in the X-axis direction. The signal lines 22 extend away from the end 11 in an X-axis negative direction. As illustrated in FIGS. 1 and 2, the signal lines 22 extend parallel to two edges 12 of the FFC 10 in the lengthwise direction. The edges 12 are respectively located at both ends of the FFC 10 in the Y-axis direction.

As illustrated in FIGS. 3 and 4, “B” is defined as an insertion length of the FFC 10. The insertion length B indicates a length of a portion of the FFC 10. Here, the portion is adjacent to the end 11 and inserted into an unillustrated connector. The insertion length B is greater than the terminal length A.

As illustrated in FIGS. 1, 3, and 4, the FFC 10 further includes a reinforcement plate 50. The reinforcement plate 50 provides rigidity to the FFC 10. The reinforcement plate 50 is positioned adjacent to the end 11 and covers part of the first insulating layer 30.

As illustrated in FIGS. 1, 2, and 4, the FFC 10 further includes two through holes 15 each of which goes through the FFC 10 in the Z-axis direction. The through holes 15 are rectangular in shape. A longitudinal (lengthwise) direction of each through hole 15 is parallel to the X-axis direction. A widthwise direction of each through hole 15 is parallel to the Y-axis direction. Each through hole 15 has a dimension L1 in the lengthwise direction and a dimension W in the widthwise direction. Each through hole 15 corresponds to one example of a “through-part”.

As illustrated in FIGS. 1 to 4, the through holes 15 are adjacent to the reinforcement plate 50 at a position farther from the end 11 than the terminals 21 in the X-axis direction. In addition, as illustrated in FIGS. 1 and 2, the through holes 15 are located at respective outer sides of the terminals 21 and the signal lines 22 in the Y-axis direction.

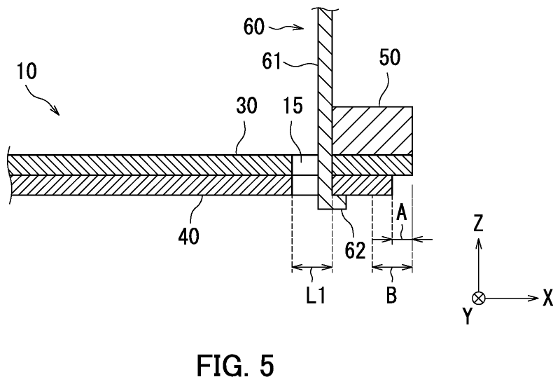

A handling method of the FFC 10 will next be described with reference to FIGS. 1 to 5. FIG. 5 is a cross-sectional view of the FFC 10 and illustrates a handling method thereof.

A robot lifts the FFC 10 up using two L-shaped hands 60. FIG. 5 depicts only one of the L-shaped hands 60. Each L-shaped hand 60 is made of for example metal wire and includes a vertical portion 61 and a horizontal portion 62. Here, the vertical portion 61 extends in the Z-axis direction, while the horizontal portion 62 extends from a lower end of the vertical portion 61 in the X-axis positive direction.

A wire thickness of each L-shaped hand 60 is smaller than the dimension W of each through hole 15 in the widthwise direction in FIG. 2. A length of the horizontal portion 62 is smaller than the dimension L1 of each through hole 15 in the lengthwise direction. This therefore enables the robot to cause the horizontal portions 62 to pass through the through holes 15 by moving the L-shaped hands 60 from above the FFC 10 to the through holes 15 in a Z-axis negative direction.

As illustrated in FIG. 5, the above configuration enables the robot to easily lift the FFC 10 up by hooking the L-shaped hands 60 to the FFC 10 through the through holes 15. The robot can insert the FFC 10 into an unillustrated connector by further moving the L-shaped hands 60 in the X-axis positive direction. During the time, the vertical portions 61 are in contact with the reinforcement plate 50, thereby enabling the robot to effectively transmit a force pushing the FFC 10 to the reinforcement plate 50. Thus, the robot can easily insert the FFC 10 into the connector. Note that the respective lengths of the horizontal portions 62 are designed to prohibit respective tips of the horizontal portions 62 from entering an area in the range of the insertion length B from the end 11.

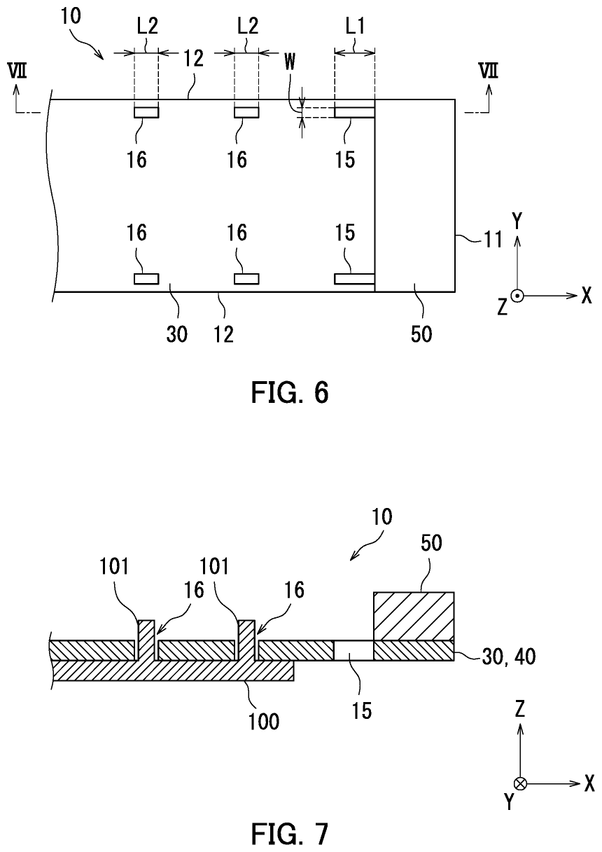

An FFC 10 that is a variation will next be described with reference to FIGS. 6 and 7. FIG. 6 is a plan view of the FFC 10 of the variation. FIG. 7 is a cross-sectional view taken along a line in FIG. 6.

The FFC 10 illustrated in FIGS. 6 and 7 differs from the FFC 10 illustrated in FIGS. 1 to 4 in that the FFC 10 as the variation further includes positioning holes 16 going through the FFC 10 in the Z-axis direction. The positioning holes 16 are aligned in a straight line along each of two edges 12. The positioning holes 16 are rectangular in shape. Each of the positioning holes 16 has a dimension L2 in its own longitudinal direction. Each positioning hole 16 corresponds to one example of the “through-part”.

FIG. 7 depicts a wiring guide 100 provided with protrusions such as bosses 101. The FFC 10 is easily positioned as a result of the bosses 101 being inserted into the positioning holes 16.

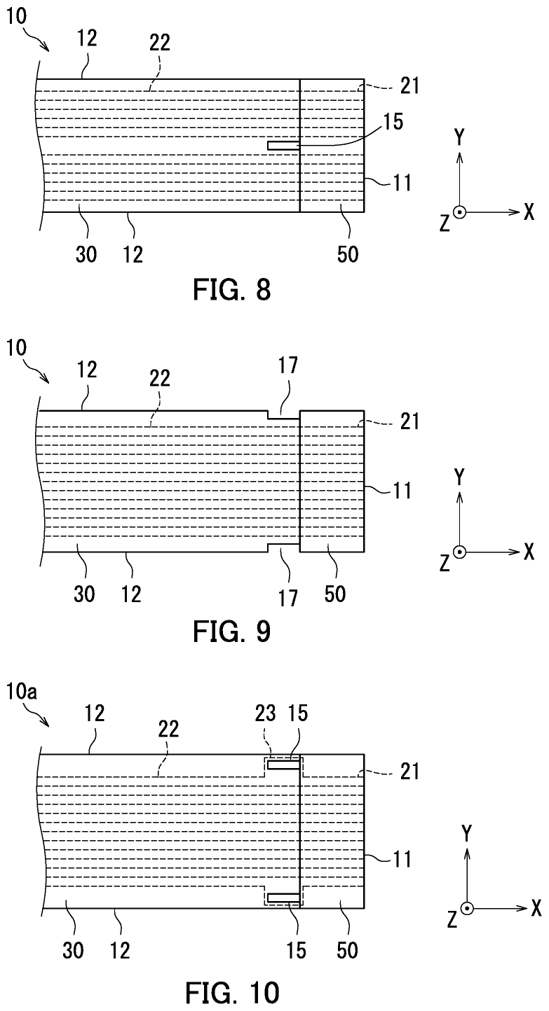

An FFC 10 that is another variation will next be described with reference to FIG. 8. FIG. 8 is a plan view of the FFC 10 in the present variation.

The FFC 10 illustrated in FIG. 8 differs from the FFC 10 illustrated in FIGS. 1 to 4 in that the number of through holes 15 in the present variation is one. The through hole 15 in the present variation is adjacent to a reinforcement plate 50 at a position farther from an end 11 of the FFC 10 than terminals 21 of the FFC 10 in the X-axis direction. The through hole 15 is located substantially at a center of the FFC 10 in the Y-axis direction. The terminals 21 and signal lines 22 of the FFC 10 are distributed on both sides of the through hole 15.

An FFC 10 that is still another variation will next be described with reference to FIG. 9. FIG. 9 is a plan view of the FFC 10 in the present variation.

The FFC 10 illustrated in FIG. 9 differs from the FFC 10 illustrated in FIGS. 1 to 4 in that the FFC 10 in the present variation is provided with cuts 17 in place of the through holes 15.

As illustrated in FIG. 9, the FFC 10 includes two cuts 17 each of which goes through the FFC 10 in the Z-axis direction. The cuts 17 are rectangular in shape. A longitudinal (lengthwise) direction of each cut 17 is parallel to the X-axis direction. A widthwise direction of each cut 17 is parallel to the Y-axis direction. Each cut 17 corresponds to one example of the “through-part”.

The cuts 17 in the present variation are adjacent to a reinforcement plate 50 at a position farther from the end 11 than the terminals 21 in the X-axis direction. In addition, the cuts 17 are located at respective outer sides of the terminals 21 and the signal lines 22 in the Y-axis direction.

The above configuration enables the robot to easily lift the FFC 10 up by hooking the L-shaped hands 60 to the FFC 10 through the cuts 17. The cuts 17 are provided adjacent to the reinforcement plate 50, thereby enabling the robot to effectively transmit a force pushing the FFC 10 to the reinforcement plate 50. Thus, the robot can easily insert the FFC 10 into an unillustrated connector.

An FPC 10a that is a connection member according to another embodiment of the present disclosure will next be described with reference to FIG. 10. FIG. 10 is a plan view of the FPC 10a.

The FPC 10a illustrated in FIG. 10 differs from the FFC 10 illustrated in FIGS. 1 to 4 in that respective signal lines 22 closest to both edges 12 have their respective detours 23. Unlike the FFC 10, the FPC 10a includes a signal layer 20 having a multilayer structure, and it is therefore easy to form the detours 23. Each of the detours 23 passes between a corresponding edge 12 and a corresponding through hole 15. The edges 12 are accordingly reinforced against external force.

The embodiments of the present disclosure have been described with reference to FIGS. 1 to 10. Note that the present disclosure can be implemented in various modes without departing from the gist of the present disclosure and is not limited to the above embodiments.

Although each embodiment of the present disclosure provides for example one or two through holes 15 that are adjacent to the reinforcement plate 50, the present disclosure is not limited to this. The number of through holes 15 may be three or more.

Although each embodiment of the present disclosure provides the positioning holes 16, the cuts 17, or one or two through holes 15 that are rectangular in shape, the present disclosure is not limited to this. Another shape such as circular or elliptical may be employed.

Although the embodiments of the present disclosure provide the cuts 17 and one or two through holes 15 that are adjacent to the reinforcement plate 50, the present disclosure is not limited to this. It is however preferable that the cuts 17 and one or two through holes 15 be provided immediately near the reinforcing plate 50.

Although the embodiments of the present disclosure provide the FFC 10 and the FPC 10a each of which includes its own reinforcement plate 50, the present disclosure is not limited this. The present disclosure is applicable to an FFC 10 or an FPC 10a with no reinforcement plate 50.

What is claimed is:

1. A connection member, comprising
at least three layers of a signal layer, a first insulating layer, and a second insulating layer, the connection member having a plate shape or a sheet shape, wherein
the signal layer is sandwiched between the first and second insulating layers,
the signal layer is provided with a terminal and a signal line connected to the terminal,
the terminal is positioned adjacent to an end of the connection member in a lengthwise direction of the connection member and exposed from the second insulating layer,
the signal line extends away from the end of the connection member, and
the connection member further comprises a through-part going through the connection member in a thickness direction of the connection member, the thickness direction intersecting the lengthwise direction.

2. The connection member according to claim 1, wherein
the through-part includes at least one through hole going through the connection member in the thickness direction.

3. The connection member according to claim 2, wherein
a longitudinal direction of the through hole is parallel to the lengthwise direction.

4. The connection member according to claim 1, wherein
the through-part includes at least one cut going through the connection member in the thickness direction.

5. The connection member according to claim 1, further comprising
a reinforcement plate that provides rigidity to the connection member, wherein
the reinforcement plate is positioned adjacent to the end of the connection member and covers part of the first insulating layer, and
the through-part is adjacent to the reinforcement plate at a position farther from the end of the connection member than the terminal in the lengthwise direction.

6. The connection member according to claim 1 comprising, as the through-part, through-parts, wherein
the through-parts are located at both outer sides of the terminal and the signal line in a widthwise direction intersecting the lengthwise direction.

7. The connection member according to claim 1, wherein
the through-part includes at least one positioning hole going through the connection member in the thickness direction, and
a protrusion of a wiring guide is inserted into the at least one positioning hole.

8. The connection member according to claim 1, wherein
the through-part is located at a center of the connection member in a widthwise direction intersecting the lengthwise direction.

9. The connection member according to claim 1, wherein
the signal line includes a detour that avoids the through-part.
